(19) United States
(12) Patent Application Publication
(10) Pub. No.: US 2012/0017050 A1
(43) Pub. Date: Jan. 19, 2012

(54) LOCAL CACHE PROVIDING FAST CHANNEL CHANGE

(75) Inventor: Stephen J. Kraiman, Doylestown, PA (US)

(73) Assignee: ARRIS GROUP, INC., Suwanee, GA (US)

(21) Appl. No.: 13/009,525

(22) Filed: Jan. 19, 2011

Related U.S. Application Data
(60) Provisional application No. 61/363,862, filed on Jul. 13, 2010.

(51) Int. Cl. G06F 12/08

(52) U.S. Cl. 711/136; 711/118; 711/E12.022; 711/E12.017

(57) ABSTRACT

Methods, systems, and apparatuses facilitate the processing of requests for media content, which can originate from a request by a user or device to change a channel. The media content for a subset of channels can be locally cached and fetched for quick retrieval.

### TECHNICAL FIELD

This disclosure relates to storing, requesting, and receiving media content upon a user request, which can be a channel change.

### BACKGROUND

More companies are delivering media content, which can be movies, music, or documents, using an IP based delivery network. For movie content, the term IP-Video or IPTV has been used. This disclosure describes caching systems and methods that can operate to shorten the time between the moment that content is requested by a user and the moment that the requested content begins to appear on his or her display, or the moment it is recorded.

### BRIEF DESCRIPTION OF THE DRAWINGS

FIG. 1 is a diagram illustrating an example network environment showing a network edge serving office coupled to customer premises equipment (CPE) at or near one or more user's premises.

FIG. 2 is a diagram illustrating a CMTS operable to cache media content and process requests for media content from CPE devices such as a gateway (GW) device and/or other CPE devices.

FIG. 3 is a diagram illustrating an example of the data associated with a channel cache.

FIG. 4 is a flow diagram illustrating an example of a process that can be performed by a GW device that has channel cache that stores media content.

FIG. 5 is a flow diagram illustrating and example of a process for incrementing a channel associated with the channel cache.

Like reference numbers and designations in the various drawings indicate like elements.

### DETAILED DESCRIPTION

In implementations of this disclosure, systems and methods can operate to facilitate the processing of requests for media content, which can originate from a request by a user to change a channel. In addition to receiving and processing content by way of a multi-cast multimedia stream, the media content for a subset of channels can be locally cached and fetched for quick retrieval and display or recording of content.

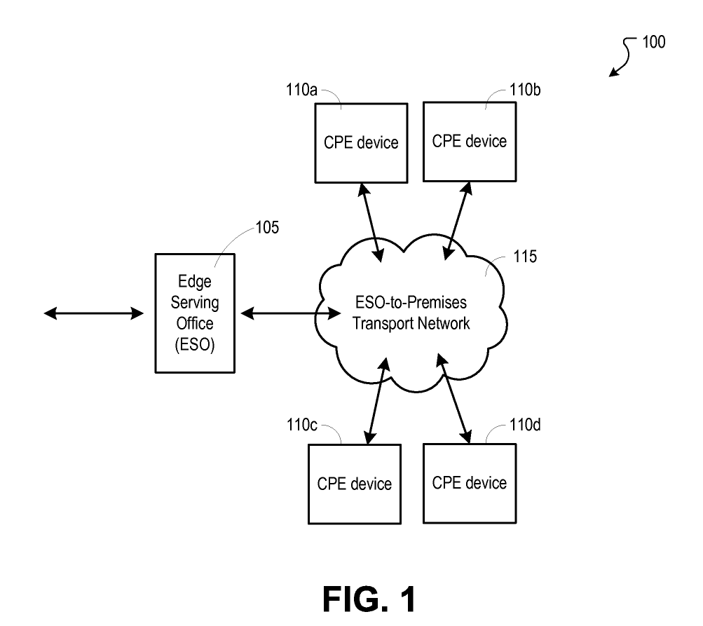

FIG. 1 is a block diagram illustrating an example network environment that can be part of a communications network that can be used as an IPTV or IP Video delivery network that transports or delivers data files and media content, including via multicast transmissions. The network environment 100 can include an edge serving office (ESO) 105, which can be a headend or central office of a multiple service provider (MSO) such as a cable, satellite, or telephone company. The ESO 105 can contain various communications equipment, such as one or more modulation/demodulation devices, a content server, and other communications equipment that can provide video, data, and/or voice service to a user. The communications equipment at the ESO 105 can be operable to communicate with one or more user devices, which can be customer premises equipment (CPE) devices 110a-d. CPE devices 110a-d can be located at or near a user's premises. Alternatively, CPE devices 110a-d can include one or more mobile devices, even though they are designated as “customer premise” devices. In FIG. 1, only four CPE devices 110a-d are shown for illustrative purposes, but more or less can be deployed.

Still referring to FIG. 1, the communications equipment at the ESO 105 can communicate with one or more CPE devices 110a-d through a transport network 115. Examples of an ESO-to-Premises transport network 115 can include one or more hybrid-fiber coaxial (HFC) networks and/or RF over Glass (RFoG) networks. An example HFC network can use a combination of optical fibers and coaxial cable to send data to and receive data from the communications equipment at the edge serving office 105. One or more RFoG networks can be deployed with existing HFC networks. RFoG networks typically include an all-fiber service from the edge serving office 105 to a field node, or optical network unit (ONU), which is typically located at or near the user's premises. Coaxial cable can be used to connect the ONUs of an RFoG network to one or more user devices 110a-d. Additionally, any other wired or wireless networks can be used, including Passive Optical Networks (PON), Gigabit Passive Optical Networks (GPON), Digital Subscriber Line (DSL), Wi-MAX, or copper twisted-pair.

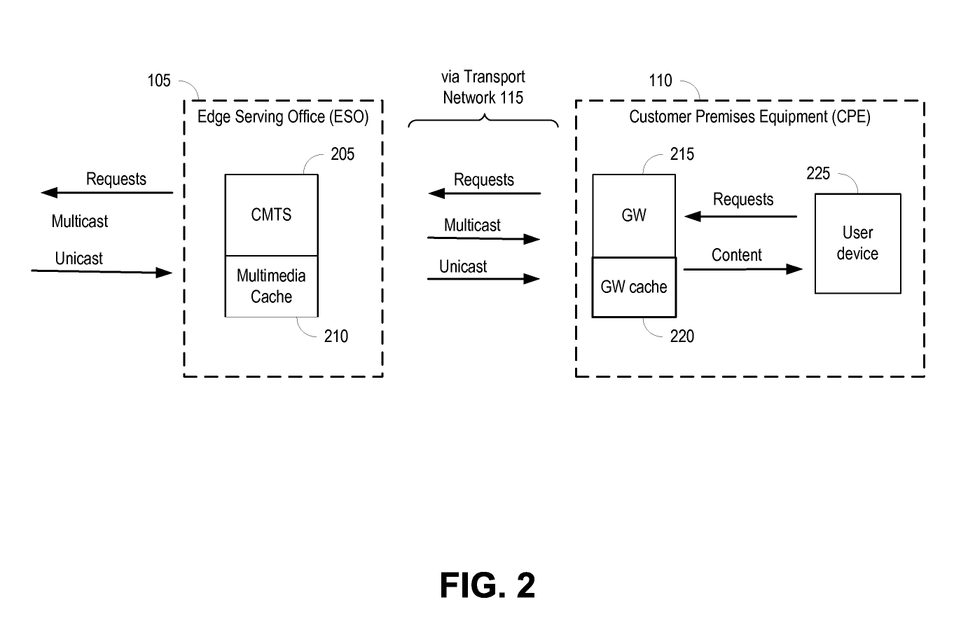

FIG. 2 is a diagram illustrating a CMTS 205 operable to cache media content from multicast streams and process requests for media content from CPE devices 110 such as a gateway (GW) device 215 and/or other CPE devices. The ESO 105 can contain a modulation/demodulation device. The demodulation/modulation device, for example CMTS 105, can include a processor, a memory, and a storage device. It can also have one or more transmitters/receivers for transmitting and receiving signals through one or more networks, including the transport network 115, to one or more user devices 110a-d. The transmitters/receivers can be one or more separate transmitter and receiver components residing on the same board, or separate boards; further, the transmitter and receiver can also include various sub-components, such as modulators and demodulators. The CMTS 205 can send to and receive data from user devices 110a-d through one or more transport networks 115 that connect the ESO to a user's premises.

In example implementations of the present disclosure, the modulation/demodulation device, for example the CMTS 205, can have associated with it a multimedia cache memory 210 that stores multimedia content. Cache memory can allow for data to be served quickly to a requesting client device, which can be the CMTS 105 having operable software that can make such a request. If the requested content is contained in the cache, a request can be served by reading the cache, as opposed to requesting the content from another source or storage location such as a hard drive and waiting for the request to be filled. In addition to the example of cache memory, any kind of memory that can allow for fast access can be used, such as volatile memory including random access memory (RAM), dynamic random access memory (DRAM), static random access memory (SRAM), content addressable memory, and dual-ported RAM. The multimedia cache 210 can reside on, for example, a blade in the CMTS 205. The CMTS 205 can run software that processes requests and places content into and fetches content out of the multimedia cache 210.

The multimedia cache can be used to cache content from multicast streams associated with a substantial number, if not all, of the “channels” that an MSO makes available to the end users of the network. A typical MSO can make available to its subscribers a plethora of channels offering standard definition video content, high definition video content, and even music content. The number of channels range, but can be hundreds of channels, or even thousands. When a user request for content is made to the CMTS 205, the CMTS 205 can be operable to fetch the content from the multimedia cache 210 and transmit it through the transport network 115 to the user's CPE device 110.

Referring to FIG. 2, individual caches in the multimedia cache 210 can contain content associated with a channel that originates from a multicast multimedia stream. Multicast addressing technology can be described as a one-to-many distribution scheme that can be used for the delivery of content to a group of destination receivers simultaneously. An IP multicast is often used in the delivery of content in IP video or IPTV services. In an IP multicast, the content source uses an IP multicast group address as the destination address of the content. Destination receivers, for example a user's CPE device 110, can use the group address to request content—that is, subscribe to the multicast by indicating that they would like to receive the content sent destined with that group address. When a user's device 110 requests that it would like to receive content sent to a group, wherein each group has a number associated with it, for example, 224.1.0.5, the user's device will request to join 224.1.0.5. IGMP is a protocol that can be used when the user device wishes to “join” a group. Thus, an IGMP join request can be sent. Distribution trees are then set up within the network, for example using PIM (protocol independent multicast) so that the user device 110 (and any other user devices that requested to join) starts receiving content sent to the group 224.1.0.5.

In example implementations, when multimedia content for a channel is received by the CMTS 205 via a multicast multimedia stream, the CMTS 205 can include software that is operable to store the content associated with each channel in a channel cache in the multimedia cache 210. The content cached can be in the form of data files, MPEG4 fragments, MPEG2 transport streams, etc. In some implementations, each channel cache of the multimedia cache 210 can be designed such that it stores a limited amount of content. The content stored in each cache can be, for example, a few seconds of video (for example, 30 seconds) associated with a channel. Content can be stored and discarded from the cache on a FIFO basis—that is, as content associated a channel is received and stored, the older content in the cache is discarded; thus, the most recent chunk of content will replace the oldest chunk of content. The CMTS 205 can also have software operable to fetch the content from the cache when it receives a request. The CMTS can also have software making it operable to send IGMP join requests, for example, upstream via a switch or router.

In other example implementations the multimedia cache 210 can reside on a device separate from the CMTS 205, such as a server, or any device that also houses or is attached to the multimedia cache. The server can also have software that makes it operable to place the multimedia content received via multicast streams into the multimedia cache 210, and fetch the multimedia content upon requests, for example those that originate from CPE devices 110a-d.

Still referring to FIG. 2, communications from the ESO 105 can be transmitted to a CPE device 110. For illustrative purposes, only one CPE device 110 is shown. However, one or more CPE devices can reside at a user's premises, and more than one CPE device can be coupled to the ESO. CPE devices can be, for example, cable modems, EMTAs (also known as cable telephony modems), televisions, residential gateways, set-top boxes, other customer premises equipment, and even mobile devices. A CPE device 110 can be operable to process communications sent to and received from communications equipment at an ESO 105. In some implementations, the CPE device 110 can have modulator(s)/demodulator(s) and routers and/or switches that can process multimedia streams and send join requests. The CPE device 110 can be, for example, a set-top box that is operable to respond to a channel change request, send join requests, receive multimedia streams and content, record content, and/or send the content to a display device for display.

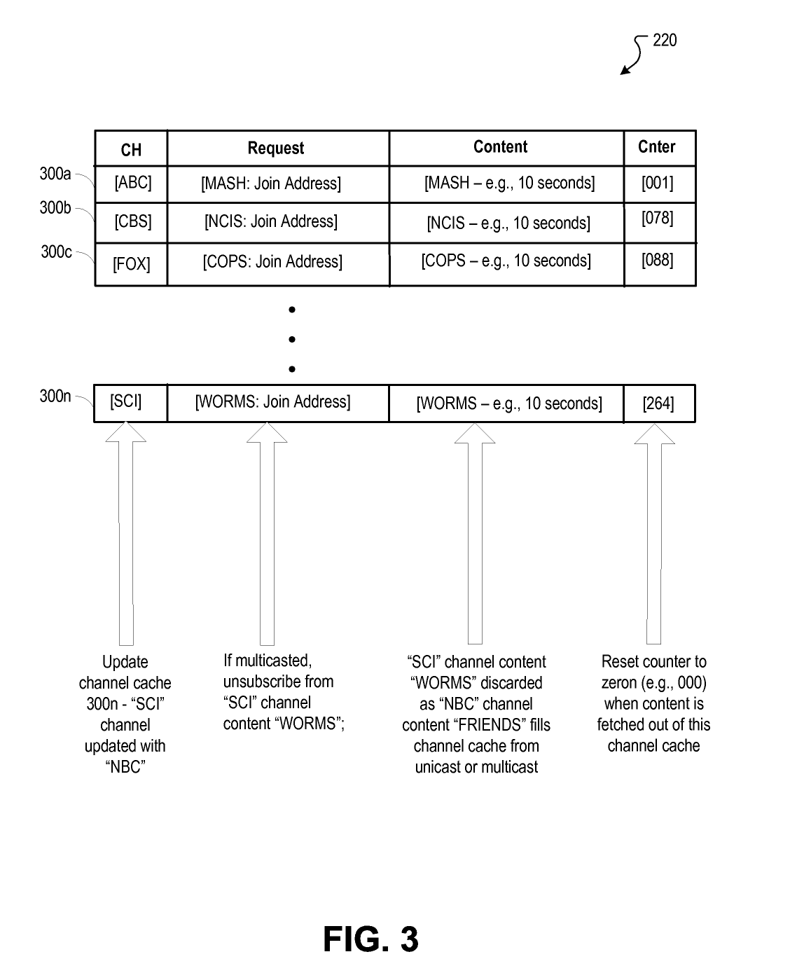

In the example implementation shown in FIG. 3, the CPE device 110 is shown as a separate gateway device 215 (GW 215) having cache memory (referred to herein as gateway cache or GW cache 220). The gateway device 215 is often referred to as a residential gateway or home gateway, although gateway devices can reside at a user's premises that is a place of business, commerce, or public gathering. The GW device 215 can perform switching and routing and modulation/demodulation functions. The GW device 215 can also be connected to one or more user devices 225, such as a set-top box that can receive content from the gateway for recording or display, or a television set that can do the same. A user device 225 can be responsive to commands initiated by a user through a remote control, for example.

The GW cache memory 220, like the multimedia cache 210, can be made up of one or more individual caches to accommodate content associated with a specific channel (“channel cache”) that is part of an MSO's channel offering. The GW device 215 can have software that makes the GW device operable to store, for example, content from multimedia streams in a cache (e.g., GW cache 220); to fetch content from the cache to send to the user device 225; and to receive requests for content from the user device 225.

The GW cache 220 can be designed to cache content from multicast multimedia streams for a substantial number, if not all, of the channels that an MSO makes available, just like the multimedia cache 210 associated with the CMTS 205. If the GW cache 220 cached the content for every channel that an MSO offers, then each time a request is made for the content (for example, as initiated when a user changes the channel), the requested content can be quickly retrieved from the cache for display on the user's screen. Because every channel's content has been cached at the GW cache 220, each channel change results in minimal delays between the moment a user selects a new channel and the moment in which the content begins to appear on the user's display. However, the caching of hundreds of channels (for example, 250 channels) can result in an increased cost due to the physical memory size requirement of more cache memory and more processing.

In the example implementations of this disclosure, the GW cache 220 contains the content for a smaller subset of channels. According to at least one source of news, Nielsen Media Research, the average household watches 15.7 channels. Based on this research, the GW cache can accommodate, for example, twenty channel caches, although more or less channels' content can be cached. Which twenty channels are to be cached can be determined by a variety of methods. For example, the GW can have software operable to determine which twenty channels are the most watched at the user's premises and associate each channel cache in the GW cache 220 with those twenty channels. The determination of the twenty most watched channels can be based on, for example, continuous samples over some time period. In other implementations, the determination can be made based on which twenty channels are most watched at the user's premises based on the night. Thus, the twenty cached channels for Monday night might be different from the twenty cached channels on Friday night.

FIG. 3 shows an example implementation of a GW cache 220 in which a “least recently used” methodology can be used to determine which twenty channels' content to cache. In this example implementation, the content and channel that is the least recently used can be disassociated from one of the twenty channel caches. In this example, the content from multicast multimedia streams can be cached in twenty channel caches 300a-n, whereby a-n in this example can be 1 through 20. Each channel cache 300 can contain, for example, the channel, subscription information, such as a IGMP join group number or address, content associated with a channel, and a counter. As with the content cached at the multimedia cache 210, the content cached can be in the form of data files, MPEG4 fragments, MPEG2 transport streams, etc. Each channel cache 300a-n of the GW cache 220 can be designed to store only a limited amount of content. The content stored in each channel cache 300 can be, for example, a few seconds of video (for example, 10 seconds) associated with a channel. Content can be stored and discarded from channel cache 300 on a FIFO basis—that is, as content from a channel is received and stored, the older content in the channel cache 300 is discarded; thus, the most recent chunk of content will replace the oldest chunk of content. For example, in channel cache 300a, chunks of the content associated with the channel ABC currently might be the television program MASH, a television program. However, as time moves forward, chunks of content from the next program in the ABC channel lineup (for example, FLASHFORWARD) might occupy the content location in channel cache 300a.

Also associated with each channel cache 300a-n can be the channel and a counter. Each time content is fetched from any of the channel caches 300a-n, the counter for that channel cache can be reset. Thus, if a user tunes from the ABC channel streaming MASH to the CBS channel streaming NCIS, the channel cache 300b had already been caching the NCIS content. The content would be fetched from the channel cache 300b and the counter for channel cache 300b can be reset.

However, referring to FIG. 3, if a user, or user device, tunes to a channel that is not one of the twenty channels for which content is cached, then one of the channels for which content is cached and its channel content can be disassociated from the cache it had occupied. A caching rule (e.g., a cache algorithm) can be used to determine which channel is disassociated from the cache. One cache algorithm can determine, for example, the least recently used (LRU) channel. Thus, the least recently used (LRU) channel and channel content can be disassociated from the channel cache it had occupied. Other cache algorithms can include, for example, pseudo-LRU, least frequently used (LFU), or adaptive replacement cache (ARC). Those of ordinary skill can select or use any other cache algorithm suitable to disassociate a channel and its content.

As an example of LRU-based disassociation, if the user tuned from the ABC channel streaming the show MASH to the NBC channel showing FRIENDS, which is at first not associated with one of the channel caches 300a-n, the software on the GW device 215, for example, can determine the least recently used channel (in this case the SCI channel receiving the show content “WORMS,” as indicated by channel cache 300n's counter) and store the new channel (NBC) into channel cache 300n. To discontinue receiving the “WORMS” show content filling the channel cache 300n, a multicast “unsubscribe,” or IGMP “leave”, can be sent. A request to obtain content, for example using Transmission Control Protocol (TCP), and a multi-cast “subscribe,” or an IGMP “join” can be sent to obtain the new content for the NBC channel, FRIENDS. When the content FRIENDS is received, it is stored into channel cache 300n. When the content for the show FRIENDS is fetched from channel cache 300n for recording or display, the counter for channel cache 300n can be reset, for example, to 000.

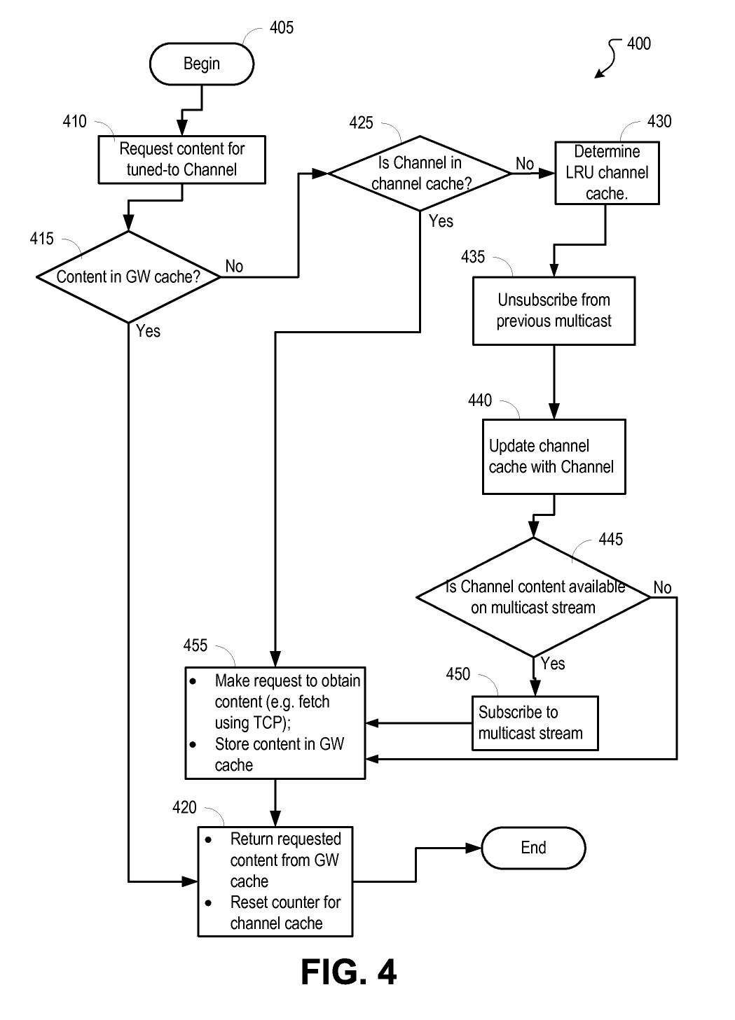

FIG. 4 is flowchart illustrating an example of an iterative process 400 that can be performed. The process can be performed, for example, by the GW device 215 having software that makes it operable to perform the process 400. The process can begin at stage 405. In the first iteration, a channel change request might have been initiated by a user, for example via a remote control to a user device 225 (which can be, for example, a television or set-top box). The request could also have been a pre-set request from a user device 225 to tune to a channel, for example, for recording. By way of example, referring to FIG. 3 as well, the user might have tuned from the ABC channel streaming MASH to the FOX channel streaming COPS. At stage 410, a request can ask the GW device 215 to obtain or pull content from the channel cache associated with the channel the user has selected. The request can be sent by the user device 225. At stage 415, a determination can be made as to whether the content for the channel requested has been cached in one of the channel caches 300a-n of the GW cache 220. If the content is in one of the channel caches 300a-n, then at stage 420, the content from that channel cache is fetched and returned to the user device 225 for display or recording, and the counter associated with the channel cache containing the content is reset to zero. In this example, a channel cache 300c is associated with the channel Fox and the content COPS. The content COPS would be fetched from the channel cache 300c and returned for viewing or recording, and the counter for channel cache 300c can be reset, for example, to zero. If the user device 225 is integrated with the GW 215, as in the case of many set-top boxes, the content can returned to the component(s) within the set-top box that processes the content for display or recording. Because the content was cached, the user would experience a quick channel change with not much delay from the moment the user made the request to the moment the user begins to see content. Each time content is fetched from a channel cache, the counter associated with that channel cache can be reset to zero.

If at stage 415 it is determined that the content requested has not been cached in one of the channel caches 300a-n, for example the NBC channel content FRIENDS as shown in FIG. 3, then the process moves to stage 425. At stage 425, a determination is made as to whether the Channel is in a channel cache. If it is not, then at stage 430 a determination can be made as to which channel cache is the least recently used (LRU). In this example, referring to FIG. 3, the channel cache associated with the SCI channel 300n has the highest counter at 264, indicating that it is the least recently used channel cache.

At stage 435, if the content in channel cache 300n (WORMS) was being multicasted, then an unsubscribe request to the show associated with channel 300n can be made to discontinue receiving the multicast stream for the SCI channel.

At stage 440, the LRU cache, in this example channel cache 300n, can also be updated with the newly requested channel, in this example NBC.

At stage 445, a determination can be made as to whether the requested content, in this example FRIENDS on the NBC channel, is available on a multicast stream from the network. If so, and if it has not been previously subscribed to, then at stage 450, a request to subscribe to the channel (for example a request to “join” the multicast stream for that channel) can be made.

After the channel cache 300n is updated with the new channel (e.g, NBC) and a request to subscribe to the channel content (e.g., FRIENDS) has been made, the process moves to stage 455, in which a request to receive the content associated with the channel, for example to fetch the content using TCP, can also be made. It can take longer for a multicast subscription process to be completed (e.g., for the IGMP join request to be processed), and thus longer for the content from the multicast multimedia stream for the channel to be cached. To minimize the delay the user experiences when the user changed to the channel, a TCP fetch request for the content can be made. Once the content is received via the TCP fetch, the content, in this case FRIENDS, can be stored in the channel cache 300n for retrieval while waiting for content from the multicast stream for the channel to arrive and be cached.

The process can move to stage 420. Once the content is in channel cache 330n, it can be fetched and returned at stage 420 and the counter for the channel cache reset.

If at stage 445 the channel content (FRIENDS) is not available via multicast, then there is no need to send a subscribe request to join it and stage 450 can be bypassed. At stage 455, a request, for example a TCP fetch request, is made to obtain the content, and once the content arrives it can be stored in the channel cache 300n, in this example. And once the content is in channel cache 330n, it can be fetched and returned at stage 420 and the counter for the channel cache reset.

In the next iteration, beginning at 405 again, the channel NBC had been selected in the last iteration but, as determined in stage 415, the channel cache 300n might not yet have been filled, although a subscription request, for example a TCP fetch request, multicast subscribe, or IGMP join request, had already been made in the last iteration and, as determined at stage 425, the channel NBC is already associated with a channel cache (in the example, channel cache 300n). In this situation, at stage 425, it might have been that the multicast stream for the selected channel had already been made, and another IGMP join request need not be made. But, because the channel cache has not been filled yet by content from the multicast stream, at stage 455, another TCP fetch content request can be made so that the cache can be filled with pre-loaded content while awaiting the multicast stream. Once content is in channel cache 330n, it can be fetched and returned at stage 420 and the counter for the channel cache reset.

As mentioned, in the example process 400, the counter is reset each time content is pulled from one of the channel caches 300a-n. If the user changes the channel, for example from ABC to CBS, the requests for content for ABC channel will discontinue—the content is no longer being pulled from the cache for display, although the channel cache 300a for ABC continues to be filled on a FIFO basis as described above. Because the content is no longer being fetched (i.e., because the user is watching CBS and that CBS's content is being pulled from channel cache 300b), the counter for channel cache 300a continues to be incremented. If the user should tune to ABC again, the content from channel cache 300a will be pulled out, and the counter will reset to zero. On the other hand, if the user changes to a channel that is not at the time associated with one of the twenty channel caches 300a-n, for example the HISTORY channel, then if the channel counter for ABC's channel cache 300a reaches a high enough count such that the channel cache 300a now becomes the LRU (least recently used), then the channel cache 300a can be updated to re-associate it with the HISTORY channel and its associated content.

Even if a channel is being watched, the counter for the channel cache associated with it can be incremented. But, although the counter is incremented, it is reset each time content is fetched from it.

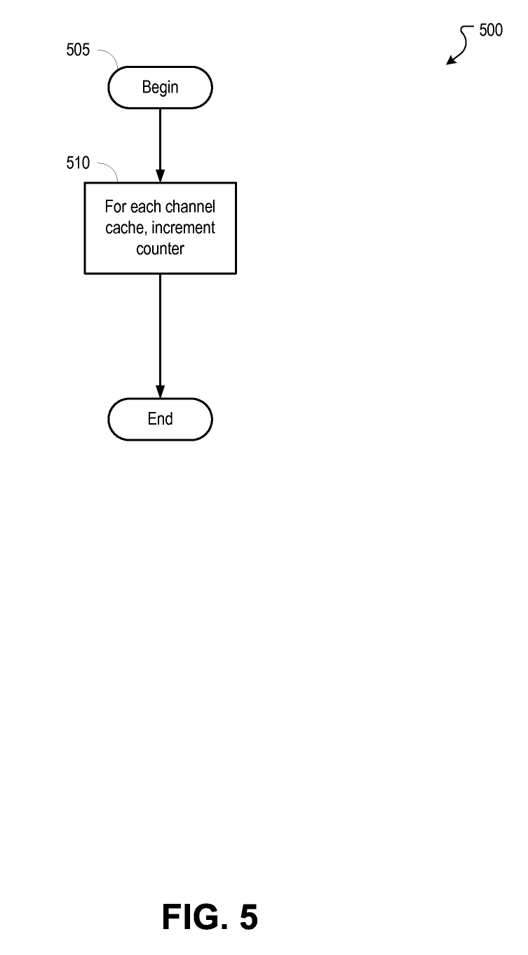

FIG. 5 is an illustration of an example routine for incrementing channel cache counters. The process begins at stage 505, in which channel caches 300a-n with counters exist within a local cache, such as GW cache 220. Each counter for each channel cache is continuously and periodically incremented at stage 510. This process continues, even after a channel cache counter has been reset from time to time.

Any of the devices (e.g., CMTS, cable modems, EMTAs, etc.) and software programs/modules described in this disclosure, and components thereof, can be realized by instructions that upon execution cause one or more processing devices to carry out the processes and functions described above. Such instructions can, for example, comprise interpreted instructions, such as script instructions, e.g., JavaScript or ECMAScript instructions, or executable code, or other instructions stored in a computer readable medium.

Implementations of the subject matter and the functional operations described in this specification can be provided in digital electronic circuitry, or in computer software, firmware, or hardware, including the structures disclosed in this specification and their structural equivalents, or in combinations of one or more of them. Embodiments of the subject matter described in this specification can be implemented as one or more computer program products, i.e., one or more modules of computer program instructions encoded on a tangible program carrier for execution by, or to control the operation of, data processing apparatus. The tangible program carrier can be a propagated signal or a computer readable medium. The propagated signal is an artificially generated signal, e.g., a machine generated electrical, optical, or electromagnetic signal that is generated to encode information for transmission to suitable receiver apparatus for execution by a computer. The computer readable medium can be a machine readable storage device, a machine readable storage substrate, a memory device, a composition of matter effecting a machine readable propagated signal, or a combination of one or more of them.

A computer program (also known as a program, software, software application, script, or code) can be written in any form of programming language, including compiled or interpreted languages, or declarative or procedural languages, and it can be deployed in any form, including as a stand-alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform functions by operating on input data and generating output thereby tying the process to a particular machine (e.g., a machine programmed to perform the processes described herein). The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. The elements of a computer typically include a processor for performing instructions and one or more memory devices for storing instructions and data. Generally, a computer will also include, or be operably coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile communications device, a telephone, a cable modem, a set-top box, a mobile audio or video player, or a game console, to name just a few.

Computer readable media suitable for storing computer program instructions and data include all forms of non volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD ROM disks. The processor and the memory can be supplemented by, or incorporated in, special purpose logic circuitry.

To provide for interaction with a user, embodiments of the subject matter described in this specification can be operable to interface with a computing device having a display, e.g., a CRT (cathode ray tube), LCD (liquid crystal display), LED (light emitting diode) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

While this specification contains many specific implementation details, these should not be construed as limitations on the scope of any invention or of what can be claimed, but rather as descriptions of features that might be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features might be described above as acting in certain combinations and even initially claimed as such, one or more features from a claimed combination can in some cases be excised from the combination, and the claimed combination might be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing might be advantageous. Moreover, the separation of various system components in the embodiments described above should not be understood as requiring such separation in all embodiments, and it should be understood that the described program components and systems can generally be integrated together in a single software product or packaged into multiple software products.

Particular embodiments of the subject matter described in this specification have been described. Other embodiments are within the scope of the following claims. For example, the actions recited in the claims can be performed in a different order and still achieve desirable results, unless expressly noted otherwise. As one example, the processes depicted in the accompanying figures do not necessarily require the particular order shown, or sequential order, to achieve desirable results. In some implementations, multitasking and parallel processing might be advantageous.

What is claimed is:

1. A method for caching multimedia content, comprising:
receiving a request for content related to a channel;
determining whether the requested content related to the channel is cached in one of a plurality of channel caches;
if the content related to the channel is not in one of the plurality of channel caches, updating the channel cache by dissociating existing content in one of the plurality of channel caches responsive to a caching rule;
sending a request for content related to the channel;
receiving content related to the channel; and
caching the content related to the channel in the updated channel cache.

2. The method of claim 1, wherein the caching rule comprises a least recently used algorithm.

3. The method of claim 1, wherein sending a request for content comprises sending a TCP request.

4. The method of claim 1, wherein sending a request for content comprises sending an IGMP Join request.

5. The method of claim 1, further comprising fetching the content from the updated channel cache and resetting the counter associated with the updated channel cache.

6. The method of claim 1, further comprising fetching the content from the channel cache having the content if the content related to the channel is in one of the plurality of channel caches.

7. A computer readable medium having stored thereon instructions for caching multimedia content, the instructions comprising:
receiving a request for content related to a channel;
determining whether the requested content related to the channel is cached in one of a plurality of channel caches;
if the content related to the channel is not in one of the plurality of channel caches, updating the channel cache by dissociating existing content in one of the plurality of channel caches responsive to a caching rule;
sending a request for content related to the channel;
receiving content related to the channel; and
caching the content related to the channel in the updated channel cache.

8. The computer readable medium of claim 7, wherein the caching rule comprises a least recently used algorithm.

9. The computer readable medium of claim 7, wherein sending a request for content comprises sending a TCP request.

10. The computer readable medium of claim 7, wherein sending a request for content comprises sending an IGMP Join request.

11. The computer readable medium of claim 7, further comprising fetching the content from the updated channel cache and resetting the counter associated with the updated channel cache.

12. The computer readable medium of claim 7, further comprising fetching the content from the channel cache having the content if the content related to the channel is in one of the plurality of channel caches.

13. A system for caching multimedia content, the system operable for:
receiving a request for content related to a channel;
determining whether the requested content related to the channel is cached in one of a plurality of channel caches;
if the content related to the channel is not in one of the plurality of channel caches, updating the channel cache by dissociating existing content in one of the plurality of channel caches responsive to a caching rule;
sending a request for content related to the channel;
receiving content related to the channel; and
caching the content related to the channel in the updated channel cache.

14. The system of claim 13, wherein the caching rule comprises a least recently used algorithm.

15. The system of claim 13, wherein sending a request for content comprises sending a TCP request.

16. The system of claim 13, wherein sending a request for content comprises sending an IGMP Join request.

17. The system of claim 13, further comprising fetching the content from the updated channel cache and resetting the counter associated with the updated channel cache.

18. The system of claim 13, further comprising fetching the content from the channel cache having the content if the content related to the channel is in one of the plurality of channel caches.
